(19) United States
(12) Patent Application Publication
(10) Pub. No.: US 2025/0270093 A1
(43) Pub. Date: Aug. 28, 2025

(54) SYSTEM AND METHOD FOR SUPERCRITICAL FLUID-FACILITATED EXFOLIATION AND EXTRACTION

(71) Applicant: Mehrdad Alibouri, Behbahan (IR)

(72) Inventor: Mehrdad Alibouri, Behbahan (IR)

(73) Assignee: Mehrdad Alibouri, Behbahan (IR)

(21) Appl. No.: 18/859,573

(22) PCT Filed: May 2, 2022
(86) PCT No.: PCT/IB2022/054020

§ 371 Date: Oct. 24, 2024

(51) Int. Cl. C01B 32/19

(52) U.S. Cl. CPC C01B 32/19

(57) ABSTRACT

A method for producing high quality exfoliated layered materials may include loading a layered material powder into a variable-volume reactor, injecting a pressurized fluid into the variable-volume reactor, increasing the temperature of the variable-volume reactor to a predetermined temperature, increasing the pressure of the variable-volume reactor up to a pressure higher than the critical pressure of the pressurized fluid at the predetermined temperature by reducing the volume of the variable-volume reactor, obtaining an intercalated layered material powder by maintaining the temperature and pressure condition within the variable-volume reactor for a predetermined amount of time, and exfoliating the intercalated layered material powder by expanding the pressurized fluid within the variable-volume reactor by increasing the volume of the variable-volume reactor. The reactor and method may be configured to perform supercritical extraction and nanoparticle production processes as well.

### TECHNICAL FIELD

The present disclosure relates to production of nanomaterials, particularly to mass production of single-layer nanomaterials, such as graphene nanoplates. More particularly, the present disclosure relates to a system and method for supercritical fluid-facilitated exfoliation of layered materials, such as graphite.

### BACKGROUND

Graphene is a single-layer, two-dimensional hexagonal crystalline array of elemental carbon atoms by sp² hybridized C—C bonds between two adjacent carbon atoms. Graphene exhibits outstanding mechanical, electrical, optical, and thermal properties that make graphene applicable for preparing sensitive sensors, energy storage, composites, conductive ink and biomedicine production.

Various methods, such as chemical exfoliation route and reduction of graphene oxide (GO) through chemical oxidation of graphite may be used for bulk production of graphene. However, graphene obtained by this method contains large amounts of lattice defects and oxygen containing groups, leading to poor mechanical, electronic and optical performances. In addition, chemical exfoliation methods use toxic chemical reagents and produce hazardous wastes. Moreover, these methods involve several steps and need 3 to 5 days to allow the intercalants and organic solvents to fully insert into the graphitic layers.

To address lattice defects and oxygen content in chemical exfoliation method, a liquid-phase exfoliation (LPE) method has been developed to produce pristine and defect-free graphene. In an LPE method, a solvent intercalates into interlayers of graphite and exfoliates graphite into isolated sheets. However, LPE processes are associated with issues, such as low yield, time-consuming processes and utilizing expensive and toxic organic solvents with high boiling points.

Other approaches for fabricating graphene sheets with high quality may include chemical vapor deposition (CVD) method and thermal decomposition of silicon carbide (SiC), which is also known as epitaxial growth. However, complexity of process, high temperature and vacuum condition, low production rate and high costs limit the possibility of industrialization of such methods. In addition, in these methods, the transfer procedure between different substrates may also induce additional defects. In the case of epitaxial growth, production of high quality graphene films needs single crystal SiC substrate, which increases process costs.

Another approach for exfoliating and intercalating layered materials such as graphite and clay is utilizing supercritical CO₂ exfoliation technology. In supercritical CO₂ exfoliation method, pressurized supercritical CO₂, due to its high diffusivity, low viscosity, and zero surface tension, may be inserted between graphite layers to intercalate graphite. Then, a rapid depressurizing step may allow for exfoliating graphene sheets or layers from intercalated graphite. Here, supercritical CO₂ between layers expands due to the depressurization step and consequently the distances between layers are increased, which leads to an efficient exfoliation of graphite. In this method, the depressurization rate is a key factor.

Supercritical CO₂ exfoliation is a physical process and produces high quality pristine defect-free graphene with no increase in oxygen content of the graphite (raw material) during the production process while it happens in chemical exfoliation method because of using strong oxidant agents or in CVD method because of high temperature process. In addition, in comparison with other methods, this method is not a time-consuming process, and it takes less than 4 hours. This green process is performed in a low temperature process, less than 70° C., and CO₂ is separated from graphene during the depressurization step. Therefore, unlike chemical exfoliation and LPE methods it does not produce hazardous wastes. However, one drawback of supercritical CO₂ exfoliation is the difficulty in scaling up the process to produce larger amounts of graphene. There is, therefore, a need for developing a system and method for supercritical fluid-facilitated exfoliation that may allow for large scale production of high quality graphene.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a supercritical fluid-facilitated exfoliation method. An exemplary method may include loading a layered material powder into a variable-volume reactor. An exemplary variable-volume reactor may include an elongated enclosure, a piston moveably disposed within the elongated enclosure, where an exemplary piston may divide an interior of the elongated enclosure into a first chamber and a second chamber. Loading an exemplary layered material powder into an exemplary variable-volume reactor may include loading an exemplary layered material powder into an exemplary first chamber.

An exemplary method may further include injecting a pressurized gas into an exemplary first chamber, increasing the temperature of an exemplary first chamber to a predetermined temperature by heating an exemplary first chamber, increasing the pressure of an exemplary first chamber up to a pressure higher than the critical pressure of an exemplary pressurized gas by injecting a hydraulic fluid into an exemplary second chamber. An exemplary piston may move towards an exemplary first chamber thereby reducing the volume of an exemplary first chamber in response to injecting an exemplary hydraulic fluid into an exemplary second chamber.

An exemplary method may further include obtaining an intercalated layered material powder by intercalating an exemplary pressurized gas between layers of an exemplary layered material powder, where intercalating an exemplary pressurized gas between layers of an exemplary layered material powder may include maintaining the temperature and pressure condition within an exemplary first chamber for a predetermined amount of time.

An exemplary method may further include exfoliating an exemplary intercalated layered material powder by expanding an exemplary pressurized gas within an exemplary first chamber, where expanding an exemplary pressurized gas within an exemplary first chamber may include discharging an exemplary hydraulic fluid from an exemplary second chamber. An exemplary piston may move towards an exemplary second chamber thereby increasing the volume of an exemplary first chamber in response to discharging an exemplary hydraulic fluid from an exemplary second chamber.

According to one or more exemplary embodiments, the present disclosure is directed to a system for producing exfoliated layered materials. An exemplary system may include an elongated enclosure, a piston moveably disposed within an exemplary elongated enclosure dividing an inner volume of an exemplary elongated enclosure into a first chamber and a second chamber, a powder inlet port connected in powder communication with an exemplary first chamber, where an exemplary powder inlet port may be configured to allow for introducing a powder into an exemplary first chamber. An exemplary system may further include a gas injection port that may be connected in fluid communication with an exemplary first chamber. An exemplary gas injection port may be configured to allow the injection of a gas into an exemplary first chamber.

An exemplary system may further include a hydraulic mechanism that may be connected in fluid communication with an exemplary second chamber. An exemplary hydraulic mechanism may be configured to urge an exemplary piston to move along a longitudinal axis of an exemplary elongated enclosure. An exemplary hydraulic mechanism may include a hydraulic fluid reservoir containing a hydraulic fluid, and a hydraulic pump that may be connected between an exemplary hydraulic fluid reservoir and an exemplary second chamber. An exemplary hydraulic pump may be configured to pump an exemplary hydraulic fluid into and out of an exemplary second chamber. An exemplary piston may move towards an exemplary first chamber responsive to an exemplary hydraulic fluid being pumped into an exemplary second chamber. An exemplary piston may move towards an exemplary second chamber responsive to hydraulic fluid being pumped out of an exemplary second chamber. An exemplary system may further include a temperature control mechanism that may be coupled to the elongated enclosure. An exemplary temperature control mechanism may be configured to control the temperature of an exemplary first chamber.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently exemplary embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1 illustrates a schematic view of a system for producing high quality exfoliated layered materials, consistent with one or more exemplary embodiments of the present disclosure;

FIG. 2 illustrates a flowchart of a supercritical fluid-facilitated exfoliation method for producing high quality nanomaterials, consistent with one or more exemplary embodiments of the present disclosure;

FIG. 3 illustrates Raman spectra of the synthetic graphite and pristine graphene nanoplatelets, consistent with one or more exemplary embodiments of the present disclosure;

FIG. 4 illustrates an atomic force microscope (AFM) image of the produced graphene nanoplatelets, consistent with one or more exemplary embodiments of the present disclosure; and

FIG. 5 illustrates a transmission electron microscope (TEM) image of the produced graphene nanoplatelets, consistent with one or more exemplary embodiments of the present disclosure.

### DETAILED DESCRIPTION

The novel features which are believed to be characteristic of the present disclosure, as of its structure, organization, use and method of operation, together with further objectives and advantages thereof, will be better understood from the following discussion.

Generally, a supercritical CO₂ exfoliation technique may involve exposing graphite material to supercritical CO₂ in a pressurized vessel for a predetermined period and then exfoliating graphene sheets or layers from intercalated graphite by rapidly depressurizing the vessel to ambient pressure. As mentioned before, the rate of depressurization plays an important role in efficiently exfoliating graphite.

Current methods of producing graphene by supercritical CO₂ exfoliation are generally utilized at a small scale, since most systems and methods utilize a valve such as a ball valve to rapidly depressurize the vessel in which graphite is exposed to supercritical CO₂. For larger scales, a relatively huge amount of CO₂ must be released via the valve in a relatively short time. Due to Joule Thomson effect, during the rapid discharge of gas from the vessel, the temperature drops dramatically which may lead to blockage of the valve and inconsistency of the discharge flow rate. Such blockage may lead to longer discharge times, while, as mentioned before, for a successful exfoliation of graphite, rapid discharge of gas is crucial. Furthermore, a dramatic decrease in temperature during the depressurization step, which sometimes may be up to 100° C., may damage the sealings of the valve. Not to mention that a mixture of CO₂ and powder being discharged through the restricted flow path of a ball valve may further cause blockage in the valve.

In addition, in a large scale production, releasing huge amounts of CO₂ in a short time via a valve may be similar to releasing a huge amount of gas via a pressure safety valve. Such release of huge amount of gas requires special equipment for control and safety. To better understand the necessity of control for such operations, imagine an instantaneous depressurizing of a reactor with a volume of 1 m3 and pressure of 120 bar at 40° C. containing supercritical CO₂ (717.8 kg CO₂, 365.4 m3 normal volume) and powder. For comparison, a normal CO₂ cylinder has 50 lit volume (34 kg CO₂, 17.3 m3 normal volume) and a pressure of approximately 55-60 bar in ambient temperature (20° C.). Such comparison shows the abnormal conditions that one would face if one wanted to scale up a conventional supercritical CO₂ exfoliation system.

Releasing huge amount of CO₂ during this process increases CO₂ emissions. Since CO₂ pressure decreases to ambient pressure, to capture and recover the atmospheric CO₂, a low temperature cooling system and a pressurization by a CO₂ pump will be necessary. Consequently, capturing and recovering the CO₂ may become costly and energy consuming.

Conversion yield of graphite to graphene for one stage exfoliation is usually low and number of graphene layers is high, which means that the produced graphene is low quality. To address this issue, the exfoliation step needs to be repeated a few times, which means a huge amount of CO₂ as raw material must be consumed. Not to mention, that after each exfoliation step a considerable amount of CO₂ must be released into atmosphere. In addition, after each exfoliation step, produced graphene powders must be collected from the vessel and then graphite powder must be recharged into the high pressure vessel, which is time-consuming.

The present disclosure is directed to exemplary embodiments of a system and method for performing a supercritical fluid-facilitated exfoliation of a layered material such as graphite to produce a high quality nanomaterial, such as graphene. An exemplary system and method may utilize a supercritical fluid-facilitated exfoliation technique in a variable-volume reactor to produce graphene from graphite powder. Such utilization of an exemplary variable-volume reactor may allow for performing supercritical CO₂ exfoliation technique at a larger scale without facing any of the issues mentioned in the preceding paragraphs. An exemplary system may further be utilized for producing other exfoliated materials such as hexagonal boron nitride (h-BN), tungsten disulfide (WS₂), molybdenum disulfide (M₀S₂), and the like.

An exemplary system for producing high quality exfoliated layered materials may include a variable-volume reactor that may be a rodless piston-cylinder system, in which a pressurized gas, such as supercritical CO₂ may be inserted between layers of an exemplary layered material to obtain an exemplary intercalated material. An exemplary variable-volume reactor may be a jacketed reactor, where a fluid circulation system connected to an exemplary jacket of an exemplary jacketed variable-volume reactor may be utilized for controlling the temperature of an exemplary variable-volume reactor. In an exemplary system, an exemplary rodless piston may divide an internal volume of an exemplary cylinder into two chambers. A first chamber may be utilized as an exemplary variable-volume reactor for exposing a layered material powder to supercritical CO₂ and a second chamber may be utilized for charging and discharging a high pressure hydraulic fluid to change the volume of an exemplary first chamber. As used herein, cylinder may refer to a cylindrical enclosure or a cone-shaped enclosure.

An exemplary method for performing a supercritical fluid-facilitated exfoliation may include a step of loading a certain amount of layered material powder within an exemplary first chamber of an exemplary system, a step of injecting a pressurized gas, such as carbon dioxide into an exemplary first chamber from a pressurized gas source, such as a pressurized gas cylinder connected in fluid communication with an exemplary first chamber, a step of increasing the temperature of an exemplary first chamber by utilizing an exemplary circulation system up to a predetermined temperature, a step of increasing the pressure of an exemplary first chamber up to pressures higher than the critical pressure of an exemplary injected gas by decreasing the volume of an exemplary first chamber. The volume of an exemplary first chamber may be decreased by injecting high pressure hydraulic liquid into an exemplary second chamber of an exemplary system to push an exemplary rodless piston towards the pressurized gas side of an exemplary rodless piston. An exemplary method for performing a supercritical fluid-facilitated exfoliation may further include a step of maintaining the pressure and temperature conditions within an exemplary first chamber at supercritical condition of the pressurized gas within an exemplary first chamber for the pressurized gas molecules to be inserted between layers of an exemplary layered material within an exemplary first chamber. In other words, an exemplary method for performing a supercritical fluid-facilitated exfoliation may further include an intercalation step that may involve maintaining the pressure and temperature conditions within an exemplary first chamber at supercritical condition of the pressurized gas within an exemplary first chamber for the pressurized gas molecules to be inserted between layers of an exemplary layered material within an exemplary first chamber.

In an exemplary method, after the intercalation step, instead of rapid release of an exemplary pressurized gas from an exemplary first chamber as is usually done in the art, an exemplary pressurized hydraulic liquid within an exemplary second chamber is quickly discharged, which may lead to a sudden expansion of an exemplary pressurized gas within an exemplary first chamber. Such rapid expansion of gas within an exemplary first chamber may lead to exfoliation of individual layers of an exemplary layered material. Here, exemplary steps may be repeated a few times to ensure a high yield for the exfoliation process.

In exemplary embodiments, such rapid expansion of gas within an exemplary variable-volume reactor instead of a rapid discharge of an exemplary pressurized gas by utilizing a valve may allow for overcoming all the mentioned issues associated with the rapid discharge of an exemplary pressurized gas, such as valve blockage and seal breakage. Moreover, in exemplary embodiments, since an exemplary pressurized gas is not discharged into the atmosphere, an exemplary pressurized gas may be used over and over again.

For example, in case of utilizing supercritical carbon dioxide, in an exemplary method, pressurized carbon dioxide may not be released into environment, instead an exemplary pressurized carbon dioxide may be depressurized within an exemplary variable-volume reactor. Here, to prepare an exemplary system for repeating exfoliation steps, the pressure of carbon dioxide gas may simply be increased by pumping an exemplary hydraulic liquid into an exemplary second chamber. In other words, pressurizing and depressurizing an exemplary system may be performed by charging and discharging an exemplary hydraulic liquid instead of charging and discharging an exemplary pressurized gas. Since the density of an exemplary hydraulic liquid may be 1000 times higher than that of an exemplary pressurized gas, the flow rate at which an exemplary hydraulic liquid is discharged from an exemplary system may be 1000 times less than that of an exemplary pressurized gas being discharged. Such lower flowrates may address the safety and control issues of conventional supercritical CO₂ exfoliation systems.

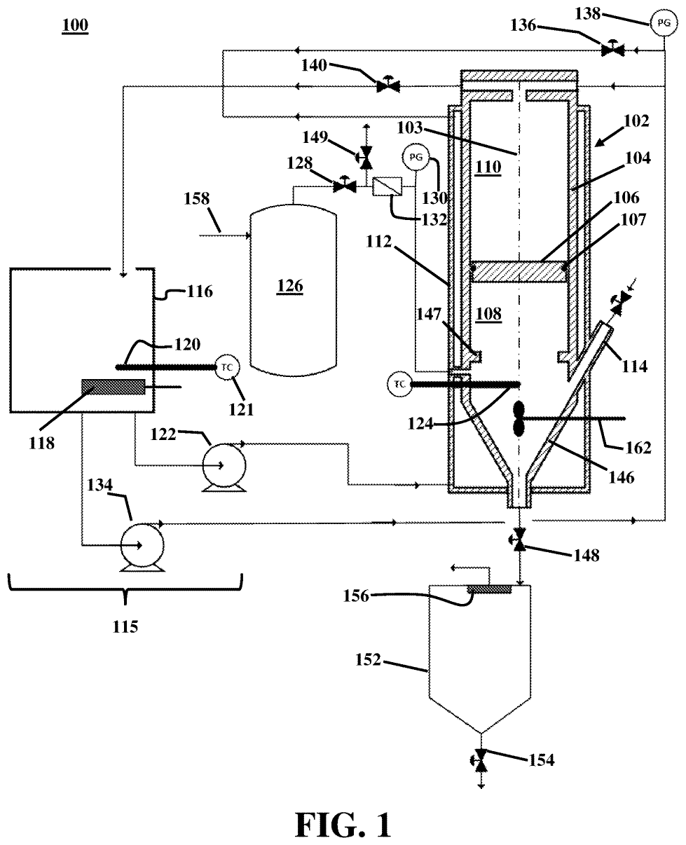

FIG. 1 illustrates a schematic view of a system 100 for producing high quality exfoliated layered materials, consistent with one or more exemplary embodiments of the present disclosure. In an exemplary embodiment, system 100 may include a variable-volume reactor 102 that may either be utilized vertically or horizontally for performing supercritical gas exfoliation technique. In an exemplary embodiment, variable-volume reactor 102 may include an elongated enclosure 104 and a piston 106 that may be moveably disposed within elongated enclosure 104. In an exemplary embodiment, piston 106 may divide an inner volume of elongated enclosure 104 into a first chamber 108 and a second chamber 110. In an exemplary embodiment, piston 106 may be a rodless piston since piston 106 is not connected to any external actuators and may be urged to move along a longitudinal axis 103 of elongated enclosure 104 in response to pressure differences between first chamber 108 and second chamber 110. For example, variable-volume reactor 102 may be configured as a cylinder-piston mechanism, where elongated enclosure 104 may be an elongated cylinder or cone and piston 106 may be an annular piston disposed within the elongated cylinder dividing the elongated cylinder or cone into two cylindrical or conical chambers, such as first chamber 108 and second chamber 110. In an exemplary embodiment, O-rings 107 may be utilized for allowing piston 106 to be moveable along longitudinal axis 103 while maintaining a fluid-tight seal between first chamber 108 and second chamber 110. In an exemplary embodiment, elongated enclosure 104 may be an elongated open ended cylinder that may be sealed off by utilizing a cap 146. In other words, elongated enclosure 104 may include a close-ended cone.

In an exemplary embodiment, layered material powder, such as graphite powder and a pressurized gas, such as pressurized CO₂ may be introduced into first chamber 108, while a pressurized hydraulic fluid, such as water may be introduced into second chamber 110. In an exemplary embodiment, linear movement of piston 106 along longitudinal axis 103 of elongated enclosure 104 maybe controlled by changing the pressure within second chamber 110 with charging and discharging the hydraulic fluid into and out of second chamber 110. For example, charging the hydraulic fluid into second chamber 110 may urge piston 106 to move towards first chamber 108 and thereby reduce the volume of first chamber 108 and compress the contents of first chamber 108. While, discharging the hydraulic fluid out of second chamber 110 may urge piston 106 to move back towards second chamber 110 and thereby increase the volume of first chamber 108 and expand the contents of first chamber 108.

In an exemplary embodiment, a mixture of gas and powder may be introduced into first chamber 108 on one side of piston 106 and a pressurized hydraulic fluid may be introduced in second chamber 110 on an opposing side of piston 106. Here, O-rings 107 may prevent pressurized hydraulic fluid to leak into first chamber 108.

In an exemplary embodiment, the hydraulic fluid may be water, a mixture of water and ethylene glycol, hydraulic oil, high temperature oil, or any other high-boiling-point liquid that may be pumped into second chamber 110 as will be discussed. In an exemplary embodiment, variable-volume reactor 102 may be utilized for exfoliating various layered materials, such as graphite powder, hexagonal boron nitride (h-BN), tungsten disulfide (WS₂) and molybdenum disulfide (M₀S₂) powder. In an exemplary embodiment, the pressurized gas that may be heated and compressed to its supercritical condition, may be CO₂ or any other suitable fluid such as water, ethanol, methanol, propanol, methane, ethane, propane, butane, ethylene, or a mixture thereof. In an exemplary embodiment, additives, such as surfactants, stabilizers, coating agents and/or reactive species such as ozone, oxygen, acid vapor or SO₃ may further be added to the pressurized gas.

In an exemplary embodiment, system 100 may further include a temperature control mechanism that may be coupled to variable-volume reactor 102 and may be configured to regulate and control the temperature within variable-volume reactor 102, specifically the temperature within first chamber 108. In an exemplary embodiment, the temperature control mechanism may include a jacket 112 that may encompass an outer surface of elongated enclosure 104, where jacket 112 may be connected in fluid communication with a water circulation system 115. In an exemplary embodiment, water circulation system 115 may be configured to control the temperature of variable-volume reactor 102 by circulating water at a predetermined temperature within jacket 112. In an exemplary embodiment, water circulation system 115 may include a water tank 116 heated by a heater 118 that may be disposed within water tank 116, a water thermocouple 120 that may be configured to measure the temperature of water within water tank 116 and that may further be connected in communication with a temperature controller 121. In an exemplary embodiment, temperature controller 121 may be configured to utilize heater 118 to control the temperature of water within water tank 116 at a given set point. In an exemplary embodiment, water circulation system 115 may include a circulation pump 122 that may be connected between water tank 116 and jacket 112 and may be configured to circulate the water within jacket 112. For example, the temperature of the circulated water within jacket 112 may be adjusted by utilizing temperature controller 121 such that the operating temperature within first chamber 108 may be adjusted at a temperature in a range of 31° C. to 90° C. For example, the operating temperature within first chamber 108 may be adjusted at a temperature of approximately 40° C.

In an exemplary embodiment, variable-volume reactor 102 may further include a powder inlet port 114 that may be connected in powder communication with first chamber 108, where powder inlet port 114 may be configured to allow for introducing a powder, such as graphite powder, into first chamber 108. In an exemplary embodiment, powder inlet port 114 may be equipped with an on/off ball valve and an exemplary powder may be poured into first chamber 108 via the ball valve by utilizing a funnel. In an exemplary embodiment, after introducing the powder into first chamber 108, powder inlet port 114 may be closed.

In an exemplary embodiment, variable-volume reactor 102 may further include a gas injection port that may be equipped with a gas injection valve 128 that may be connected in fluid communication with first chamber 108, where gas injection valve 128 may be configured to allow for introducing a pressurized gas, such as pressurized CO₂, into first chamber 108. To this end, in an exemplary embodiment, the gas injection port may be connected in fluid communication with a pressurized gas reservoir 126, such as a pressurized gas cylinder and the fluid communication between the gas injection port and pressurized gas reservoir 126 may be intercepted by gas injection valve 128 and optionally a gas filter 132 that may be configured to remove unwanted impurities from the gas stream. As used herein, fluid communication intercepted by a valve may refer to the valve being configured to connect and disconnect the fluid communication. In other words, pressurized CO₂ or any other desirable gas may be supplied from a pressurized gas source into first chamber 108 of variable-volume reactor 102.

In case of pressurized CO₂, pressurized gas reservoir 126 may contain a mixture of liquid and gaseous CO₂ at a pressure in a range of 5 bar to 73 bar. For example, pressurized gas reservoir 126 may contain a mixture of liquid and gaseous CO₂ at a pressure of approximately 35 bar. In an exemplary embodiment, responsive to gas injection valve 128 being opened, gaseous CO₂ may gradually be withdrawn from the top of pressurized gas reservoir 126 and may be introduced into first chamber 108. In an exemplary embodiment, in response to gradual introduction of pressurized gas into first chamber 108, piston 106 may be urged to move towards second chamber 110, where piston 106 may reach an extreme end of elongated enclosure 104. In this state, where piston 106 is pushed all the way towards second chamber 110 in response to the pressurized gas being injected into first chamber 108, the volume of first chamber 108 may reach a maximum and the volume of second chamber 110 may reach a minimum close to zero. After a predetermined period, for example, after 5 minutes, gas injection valve 128 may be closed. At this instant, the pressure of first chamber 108 and pressurized gas reservoir 126 are equal.

In an exemplary embodiment, a pressure gauge 130 and a reactor thermocouple 124 may be coupled to first chamber 108 to monitor the pressure and temperature of first chamber 108. For example, when pressurized CO₂ is to be used for performing the exfoliation technique, when the pressurized CO₂ is initially injected into first chamber 108 and gas injection valve 128 is closed, the temperature of variable-volume reactor 102 may be set at a temperature in a range of 31° C. to 300° C. by utilizing the temperature control mechanism of system 100 and the pressure may be in a range of 5 bar to 73 bar. For example, the temperature of variable-volume reactor 102 may be set at 40° C. by utilizing the temperature control mechanism of system 100 and the pressure may be approximately 20 bar.

In an exemplary embodiment, system 100 may further be coupled to a hydraulic mechanism that may be connected in fluid communication with second chamber 110, where the hydraulic mechanism may be configured to urge piston 106 to move along longitudinal axis 103 of elongated enclosure 104 and thereby compress the contents of first chamber 108. In other words, the volume of first chamber 108 may be reduced by urging piston 106 to move toward first chamber 108, where the pressure within first chamber 108 may be increased in response to the volume reduction caused by the movement of piston 106.

In an exemplary embodiment, the hydraulic mechanism may include a hydraulic fluid reservoir that may contain a hydraulic fluid. In an exemplary embodiment, water tank 116 may further be configured to function as the hydraulic fluid reservoir in case the fluid circulated in jacket 112 and hydraulic fluid utilized for moving piston 106 are similar. For example, both circulating fluid and pressurizing hydraulic fluid may be water. However, in an exemplary embodiment where the circulating fluid and pressurizing hydraulic fluid are not the same, a separate hydraulic fluid reservoir must be utilized.

In an exemplary embodiment, the hydraulic mechanism may further include a hydraulic pump 134 that may be connected between the hydraulic fluid reservoir (for example, water tank 116) and second chamber 110. In an exemplary embodiment, hydraulic pump 134 may be configured to pump the hydraulic fluid into second chamber 110. In an exemplary embodiment, piston 106 may move towards first chamber 108 in response to the hydraulic fluid being pumped into second chamber 110. In an exemplary embodiment, the pressure within first chamber 108 may increase up to a pressure in a range of 73 to 400 bar, for example 130 bar. In an exemplary embodiment, the hydraulic mechanism may further include a back pressure regulator 136 that may be configured to adjust the target pressure. In an exemplary embodiment, when the target pressure is reached within first chamber 108, hydraulic fluid flow may be diverted back to the hydraulic fluid reservoir. For example, in case of utilizing water as the hydraulic fluid, after reaching the target pressure, water may be diverted back to water tank 116.

In an exemplary embodiment, in case of utilizing CO₂, when CO₂ is pressurized in response to the movement of piston 106, the temperature of CO₂ may increase during a short period of time when the pressurization by hydraulic fluid is taking place, and then the temperature of CO₂ decreases to the target temperature in a short period. In other words, the generated heat due to the pressurization of CO₂ may be quickly dissipated to the circulating water in jacket 112. During temperature reduction to the target operational temperature, the CO₂ pressure may slightly decrease, which can be compensated for by charging the hydraulic fluid into second chamber 110 by utilizing hydraulic pump 134.

In an exemplary embodiment, by utilizing the hydraulic mechanism and temperature control mechanism of system 100, the pressurized gas within first chamber 108 may be maintained in its critical conditions for a predetermined amount of time. For example, in case of utilizing supercritical CO₂ for graphite intercalation, CO₂ may be maintained in its supercritical condition of 73-400 bar and 31-300° C. for a predetermined amount of time. For example, CO₂ may be maintained in its supercritical condition of 130 bar and 40° C. for a predetermined amount of time. During this period, supercritical CO₂ may be intercalated between graphite layers.

In an exemplary embodiment, variable-volume reactor 102 may further include a fluid discharge port connected in fluid communication with second chamber 110. In an exemplary embodiment, the fluid discharge port may be intercepted by a fluid discharge valve 140 that may be an on/off ball valve. In an exemplary embodiment, fluid discharge valve may intercept the fluid communication between second chamber 110 and hydraulic fluid reservoir (for example water tank 116) and may be configured to allow for a rapid discharge of the hydraulic fluid out of second chamber 110 into the hydraulic fluid reservoir.

In an exemplary embodiment, after the pressure and temperature within first chamber 108 are maintained for a predetermined amount of time for the supercritical gas molecules to be intercalated between layers of the layered powder material within first chamber 108, fluid discharge valve 140 may be opened to quickly discharge the hydraulic fluid out of second chamber 110. In an exemplary embodiment, opening fluid discharge valve 140 may lead to a quick discharge of hydraulic fluid from second chamber 110, which in turn may lead to a rapid expansion of the supercritical gas within first chamber 108. Such rapid expansion may lead to the exfoliation of the intercalated layered powdered material within first chamber 108. For example, after supercritical CO₂ and graphite powder were kept at supercritical conditions of CO₂ for a predetermined amount of time so that CO₂ molecules may be intercalated between graphite layers, fluid discharge valve 140 may be opened to quickly discharge the water out of second chamber 110 and thereby quickly expand the CO₂ within first chamber 108. Such rapid expansion of CO₂ may lead to exfoliation of the intercalated graphite. During such rapid expansion, the temperature of CO₂ suddenly decreases and rises up again quickly to the target operating temperature by the circulating water within jacket 112. During the rapid expansion step, CO₂ molecules that were intercalated between graphite layers suddenly expand, accompanied by a temperature shock, which ultimately may lead to an efficient exfoliation of the individual graphene layers.

In an exemplary embodiment, in response to rapid discharge of the hydraulic fluid out of second chamber 110, piston 106 may move quickly towards second chamber 110 and may collide with a base end of elongated enclosure 104.

In an exemplary embodiment, as mentioned before, to achieve a higher yield of conversion of graphite to graphene or a higher yield of exfoliation for any other suitable layered material, the intercalation and exfoliation steps may be repeated several times. To this end, after rapid expansion, fluid discharge valve 140 may be closed and hydraulic pump 134 may be utilized to pump water or any hydraulic fluid of choice into second chamber 110 to move piston 106 towards first chamber 108 and compress the contents of first chamber 108 back to the operating pressure and temperatures. For example, 130 bar and 40° C. in case of supercritical CO₂. Again, the supercritical conditions may be maintained for a given period of 2 to 600 minutes, for example 60 minutes for the intercalation to take place. After repeating the intercalation step, fluid discharge valve 140 may be opened one more time for the rapid expansion to occur again. Such repetition of the intercalating step and the exfoliation step may be carried out several times to achieve a desirable conversion yield. In exemplary embodiments, since repeating these steps does not require charging fresh CO₂ gas from pressurized gas reservoir 126, the operation time, cost, CO₂ consumption, and CO₂ emissions may be significantly reduced.

In an exemplary embodiment, elongated enclosure 104 may further include a product discharge port in communication with first chamber 108. In an exemplary embodiment, the product discharge port may be equipped with a product discharge valve 148 that may intercept the communication between first chamber 108 and a product collection tank 152. In an exemplary embodiment, after repeating the exfoliation of the layered material for any desired number of times, to collect the produced exfoliated product, fluid discharge valve 140 is closed and gas injection valve 128 is opened. It should be noted that the pressure of first chamber 108 is around the pressure of pressurized gas reservoir 126. Then, hydraulic pump 134 may be utilized to pump water to second chamber 110 to push piston 106 towards first chamber 108. Here, CO₂ gas may return to pressurized gas reservoir 126 after passing through gas filter 132 until piston 106 touches stopper 147. In this condition, the volume of first chamber 108 may be at least 25% more than the bulk volume of the exfoliated products. Consequently, the exfoliated product may not be compressed and the pressure of first chamber 108 may be the same as pressurized gas reservoir 126, which may be in arrange of 5 to 73 bar. For example, the pressure of first chamber 108 may be 35 bar.

In an exemplary embodiment, to collect the exfoliated products from first chamber 108, gas injection valve 128 may be closed and vent valve 149 may be gradually opened to reduce pressure to a pressure of approximately less than 5 bar. Then product discharge valve 148 may be gradually opened. All of the exfoliated product at a pressure of approximately less than 5 bar may be discharged into product collection tank 152 and excess CO₂ may be vented out of product collection tank 152 after passing a filter 156. Finally, a product valve 154 that may be installed at a bottom of product collection tank 152 may be opened to collect exfoliated powder products. It should be noted that the maximum volume of first chamber 108 during product collection may be 15% of the total volume of elongated enclosure 104, consequently, 85% of the CO₂ may be recycled back to pressurized gas reservoir 126. Such relatively high recycle percentage may allow for significantly reducing CO₂ consumption and CO₂ emission. In an exemplary embodiment, pressurized gas reservoir 126 may be equipped with a CO₂ make up line 158 that may be utilized when necessary to compensate for the amount of vented CO₂ from filter 156.

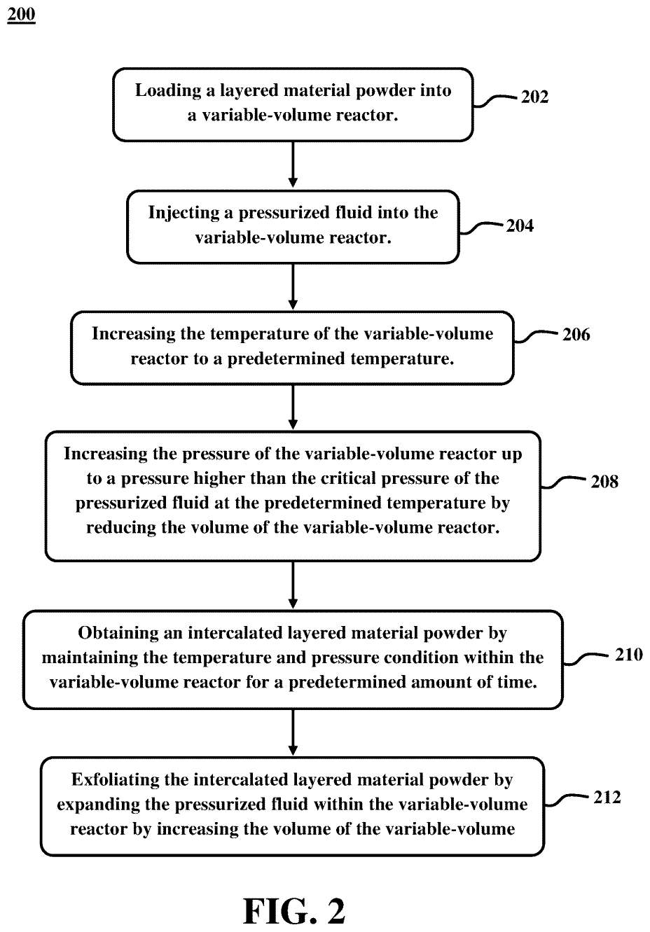

FIG. 2 illustrates a flowchart of a supercritical fluid-facilitated exfoliation method 200 for producing high quality nanomaterials, consistent with one or more exemplary embodiments of the present disclosure. In an exemplary embodiment, method 200 may be performed by a system similar to system 100.

In an exemplary embodiment, method 200 may include a step 202 of loading a layered material powder into a variable-volume reactor, a step 204 of injecting a pressurized fluid that may include a gas or any other suitable fluid such as water, ethanol, methanol, propanol, methane, ethane, propane, butane, ethylene, or a mixture thereof, into the variable-volume reactor, a step 206 of increasing the temperature of the variable-volume reactor to a predetermined temperature, a step 208 of increasing the pressure of the variable-volume reactor up to a pressure higher than the critical pressure of the pressurized fluid at the predetermined temperature by reducing the volume of the variable-volume reactor, a step 210 of obtaining an intercalated layered material powder by maintaining the temperature and pressure condition within the variable-volume reactor for a predetermined amount of time, and a step 212 of exfoliating the intercalated layered material powder by expanding the pressurized fluid within the variable-volume reactor by increasing the volume of the variable-volume reactor.

In an exemplary embodiment, step 202 of loading the layered material powder into the variable-volume reactor may include loading the layered material powder into a variable-volume reactor similar to variable-volume reactor 102. For example, powder inlet port 114 may be opened and the layered material powder may be loaded into first chamber 108 by utilizing a funnel. Then, powder inlet port 114 may be closed. In an exemplary embodiment, step 202 of loading the layered material powder into the variable-volume reactor may further include loading a stacked two-dimensional material powder including at least one of graphite powder, dichalcogenide powder, silicate clay powder, hexagonal boron nitride powder, tungsten disulfide powder, and molybdenum disulfide powder into the variable-volume reactor.

In an exemplary embodiment, step 204 of injecting the pressurized gas into the variable-volume reactor may include injecting the pressurized gas into a variable-volume reactor similar to variable-volume reactor 102. For example, the pressurized gas may be injected form a pressurized gas source such as pressurized gas reservoir 126 via a pressurized gas injection valve 128. In an exemplary embodiment, step 204 of injecting the pressurized gas into the variable-volume reactor may include opening injection valve 128 to allow for the pressurized gas to be introduced into first chamber 108. In an exemplary embodiment, step 204 of injecting the pressurized gas into the variable-volume reactor may include injecting at least one of carbon dioxide, water, ethanol, methanol, propanol, methane, ethane, propane, butane, and ethylene into the variable-volume reactor.

In an exemplary embodiment, step 206 of increasing the temperature of the variable-volume reactor to the predetermined temperature may include heating the variable-volume reactor by a temperature control mechanism. For example, the variable-volume reactor may further include a jacket similar to jacket 112 of variable-volume reactor 102 through which a circulating fluid such as water at the predetermined temperature may be circulated. In an exemplary embodiment, step 206 of increasing the temperature of the variable-volume reactor to the predetermined temperature may include circulating water at the predetermined temperature through jacket 112 of variable-volume reactor 102.

In an exemplary embodiment, step 208 of increasing the pressure of the variable-volume reactor up to a pressure higher than the critical pressure of the pressurized gas at the predetermined temperature may involve reducing the volume of the variable-volume reactor. For example, increasing the pressure of the pressurized gas to a pressure higher than the critical pressure of the gas at the predetermined temperature may include pumping a hydraulic liquid into second chamber 110 of variable-volume reactor 102 by utilizing hydraulic pump 134 to push piston 106 towards first chamber 108 and thereby reducing the volume of first chamber 108 and increasing the pressure of the pressurized gas within first chamber 108.

In an exemplary embodiment, step 210 of obtaining the intercalated layered material powder may be achieved by maintaining the supercritical conditions within the variable-volume reactor for a predetermined amount of time. As mentioned before, maintaining the supercritical conditions within first chamber 108 may allow for supercritical gas molecules have the chance to intercalate between layers of the layered material powder.

In an exemplary embodiment, step 212 of exfoliating the intercalated layered material powder by expanding the pressurized gas within the variable-volume reactor may involve increasing the volume of the variable-volume reactor. For example, increasing the volume of a variable-volume reactor such as variable-volume reactor 102 may refer to increasing the volume of first chamber 108 by rapidly discharging the hydraulic fluid from second chamber 110 which may lead to a rapid movement of piston 106 towards second chamber 110. To this end, fluid discharge valve 140 may be opened to allow for the hydraulic liquid to be discharge from second chamber 110.

### EXAMPLE

In this example, supercritical fluid-facilitated exfoliation method 200 was performed in a system similar to system 100 for producing high quality graphene from graphite powder. Here, 241.5 g of synthetic graphite powder with a mesh size of 325 and an equivalent bulk volume of 500 ml was loaded into first chamber 108 via powder inlet port 114 by utilizing a funnel. In this example, the maximum volume of elongated enclosure 104 was approximately 7 liters. Temperature controller 121 was utilized to adjust the temperature of water in water tank 116 at a temperature of approximately 40° C. Then, injection valve 128 was opened to introduce CO₂ gas from pressurized gas reservoir 126 into first chamber 108. After 5 minutes, the temperature and pressure of CO₂ gas within first chamber 108 reached 35° C. and 35 bar, respectively. Then, to pressurize the CO₂ gas well over its critical pressure, water was pumped into second chamber 110 by utilizing hydraulic pump 134, which pushed piston 106 towards first chamber 108. It took approximately one minute to reach a stable pressure of 130 bar within first chamber 108. During the above-described pressurizing step, the temperature of CO₂ suddenly increased to 90° C. and then reduced down to 35°° C. within 4 minutes. Then, graphite powder was maintained in exposure to the supercritical CO₂ at 130 bar and 35° C. for 60 minutes to obtain intercalated graphite. Then, fluid discharge valve 140 was opened which led to the discharge of water from second chamber 110 and rapid expansion of CO₂ gas in first chamber 108. During such rapid expansion, the temperature and pressure of CO₂ dropped to −5° C. and 30 bar, respectively. However, in less than 15 seconds, the temperature and pressure of CO₂ raised back up to 20° C. and 33 bar, respectively. The above described process was repeated four times and after the fourth and final cycle, all the exfoliated graphene was collected in product tank 152 by gradually depressurizing first chamber 108 using vent valve 149 to very low pressure and then opening discharge valve 148. Low pressure CO₂ flow may assist to discharge graphene powder from valve 148.

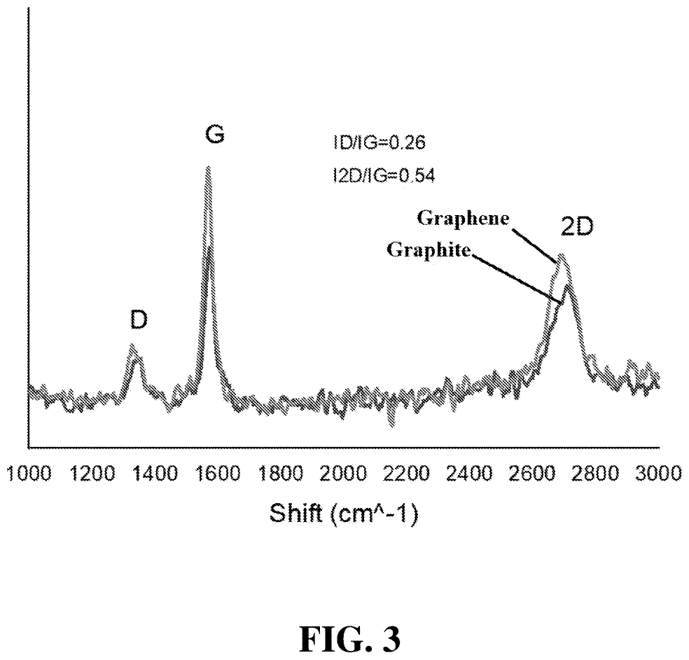

FIG. 3 illustrates Raman spectra of the synthetic graphite and pristine graphene nanoplatelets, consistent with one or more exemplary embodiments of the present disclosure. As evident in FIG. 3, 2D peak clearly shifts from 1Q1.7 (graphite) to 2689.5 (graphene) which may be considered a proof of graphene production. In addition, the ID/IG of the graphene spectra does not change in comparison with graphite spectra because the present invention uses CO₂ at low temperature (inert gas) and does not use strong oxidant or does not operate at high temperature. Therefore, there is no chance to increase oxygen and defects in produced graphene. In other words, the present invention can produce defect-free pristine graphene if high quality graphite is used as the raw material. As evident in FIG. 3, the ratio of ID/IG=0.26 is very low and approve production of very low defect graphene. In addition, the ratio of I2D/IG=0.54 is quite high for large scale production of pristine graphene which proves production of pristine graphene with few layers.

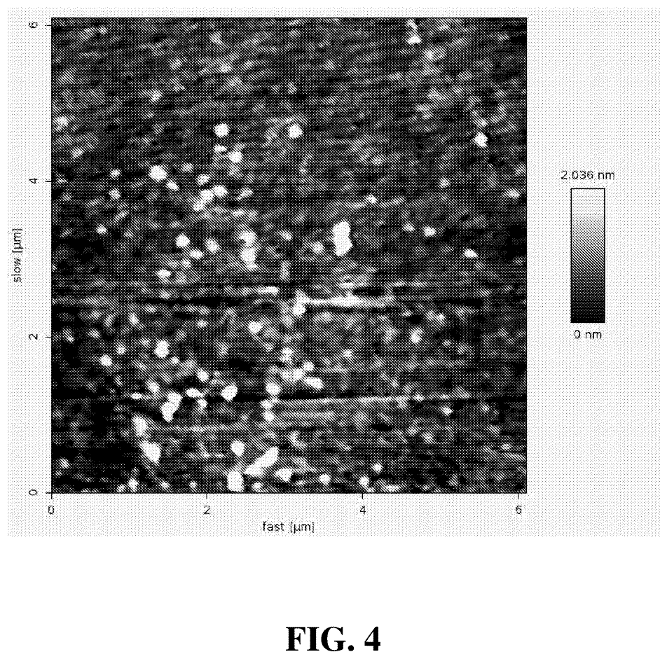

FIG. 4 illustrates an atomic force microscope (AFM) image of the produced graphene nanoplatelets, consistent with one or more exemplary embodiments of the present disclosure. As evident in FIG. 4, the maximum thickness of the pristine graphene nanoplatelets is less than 2.0 nm, which means that the average number of the layers for the pristine graphene nanoplatelets should be less than 5 layers. Hence, it has not been performed any treatment and separation (graphite from graphene) on the produced pristine graphene before AFM and Raman analysis, it may be concluded that the yield of graphene production is high and most of the graphite particles have been exfoliated to the few-layer pristine graphene with an average of less than 5 layers.

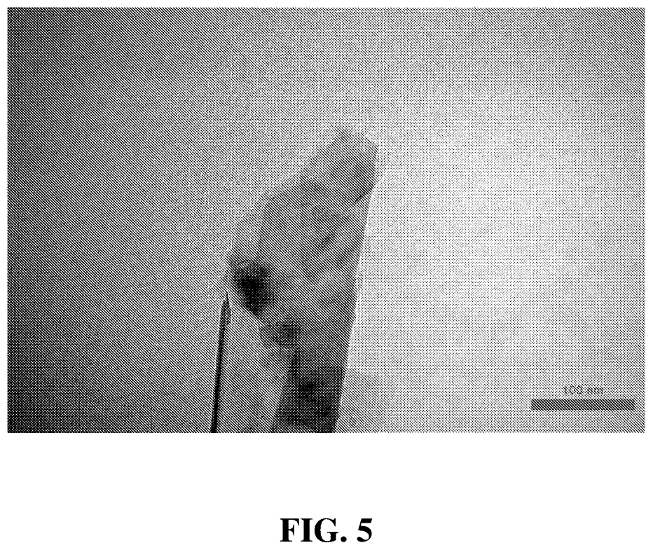

FIG. 5 illustrates a transmission electron microscope (TEM) image of the produced graphene nanoplatelets, consistent with one or more exemplary embodiments of the present disclosure. The winkle on the flake proves the thin thickness of the pristine graphene.

In exemplary embodiment, an exemplary system such as system 100 and an exemplary method, such as method 200 for supercritical fluid-facilitated exfoliation of layered materials, such as graphite may allow for overcoming the associated problems with conventional exfoliation methods. Specifically, system 100 may allow for the rapid expansion of an exemplary supercritical gas in a closed variable-volume reactor without the risk of blockage or any inconsistencies during depressurization. In addition, depressurization may be carried out via a common commercially available valve designed for the required flow rate of an exemplary pure and clean hydraulic fluid that contains no extra particles such as graphite or graphene powders, consequently there is no risk of valve blockage. Furthermore, the density of an exemplary hydraulic liquid, such as water is around 1000 times higher than the density of CO₂ gas in standard conditions. Consequently, depressurizing an incompressible fluid such as water at temperatures less than 95° C. may be considered a safe and routine process. As a result, scaling up an exemplary system to include a variable-volume reactor capable of producing 300 kg graphene per day may be possible without the need to worry about safety issues.

In exemplary embodiments, since an exemplary supercritical gas, such as supercritical CO₂ is depressurized within an exemplary variable-volume reactor as opposed to conventional methods, where the supercritical gas is discharged to the environment, CO₂ emissions is near zero. CO₂ may further be recycled for the next runs. In addition, the exfoliation process may be repeated several times within an exemplary variable-volume reactor by simply pressurizing and depressurizing the system by utilizing an exemplary hydraulic liquid. Such capability may allow for producing graphene with a higher conversion rate and higher quality without any restriction, extra process, and without high CO₂ emissions or consumption.

According to one or more exemplary embodiments, an exemplary system similar to system 100 may be configured to be utilized for extraction of one or more substances from a solid matrix using a supercritical fluid as a solvent. In an exemplary embodiment, system 100 may be configured to perform a supercritical extraction method, in which supercritical CO₂ with or without cosolvents such as methanol, ethanol and acetone may be used in the extraction of fragrances, food additives, surfactants and also oil removal. In a supercritical extraction method, a supercritical CO₂ stream passes through a packed bed of a solid matrix including one or more target substances. As used herein, exemplary target substances may refer to exemplary substances that are to be extracted from an exemplary solid matrix. An exemplary target substance diffuses and is dissolved from the solid matrix into an exemplary fresh supercritical CO₂ stream. Then the obtained supercritical solution stream is depressurized to ambient pressure and an exemplary target substance is separated from CO₂ gas. Supercritical CO₂ has high transfer properties and easy penetration characteristics in the solid matrix. Consequently, exemplary target substances, such as phospholipids may easily dissolve into supercritical CO₂ due to the high density and diffusion properties of the supercritical CO₂. Although supercritical extraction method is a promising process in food and pharmaceutical in comparison with common liquid extraction, however, transferring a target substance from inside of the solid matrix to the bulk of a supercritical CO₂ stream is controlled by molecular diffusivity, which may lead to a low extraction rate and subsequently. In other words, a considerable amount of CO₂ may be consumed in a common supercritical extraction method, which is undesirable from a practical standpoint.

In an exemplary embodiment, a variable-volume reactor such as variable-volume reactor 102 may be configured to be utilized in performing a supercritical extraction method. In an exemplary embodiment, utilizing a variable-volume reactor such as variable-volume reactor 102 for performing a supercritical extraction method may allow for accelerating the rate of extraction and production with a lower amount of CO₂ and in a shorter time. To this end, in an exemplary embodiment, instead of an exemplary layered material, variable volume reactor 102 may be charged with a solid matrix, such as buttermilk powder with or without cosolvent such as methanol, ethanol or acetone. In an exemplary embodiment, an exemplary method for supercritical extraction may be similar to method 200 with step 210 of obtaining an intercalated layered material replaced with a penetration step of a solid matrix utilizing a supercritical CO₂ fluid. However, the penetration time should be shorter because of the bigger pore size of the solid matrix in comparison with interlayer space of the layered material. In addition to molecular diffusivity of the target substance into the bulk of supercritical CO₂ (molecular extraction), a convection mass transfer (convection extraction) happens during expanding the supercritical CO₂ within variable-volume reactor 102 by increasing the volume of variable-volume reactor 102 in a very short time. In response to such rapid expansion, all the supercritical solutions of the target substance are ejected from the inside the solid matrix into variable-volume reactor 102 while supercritical CO₂ is converted to a CO₂ gas phase and the target substances, such as phospholipids are extracted. This process can be repeated a few times to complete the extraction. The final product is discharged from the variable-volume reactor 102 for further treatments.

According to one or more exemplary embodiments, system 100 may further be configured to be utilized for producing nanometric pharmaceutical particles. Here, system 100 may be utilized for performing a rapid expansion of supercritical solutions (RESS) technique. In an exemplary embodiment, variable-volume reactor 102 may further include a stirrer 162 that may be disposed within first chamber 108. In an exemplary embodiment, solute and a suitable fluid, perfectly CO₂ with or without cosolvent may be charged into variable-volume reactor 102. Then, variable-volume reactor 102 may be pressurized up to above critical pressure of the fluid by reducing its volume at a supercritical temperature adjusted by a water jacket. In an exemplary embodiment, stirrer 162 may assist in dissolving an exemplary solute into supercritical fluid. The process is then followed by a very quick expansion of variable-volume reactor 102, which may lead to an instantaneous depressurization, supersaturation of the fluid and production of the solute nanoparticles. Since the diameter of the variable-volume reactor 102 may be much larger than the common nozzles used in a common RESS processes, there may be no chance to reach supersonic speeds within variable-volume reactor 102 and particles growth by coagulation. Such configuration of system 100 may allow for producing very small nanoparticles with a narrow size distribution, which is desirable in the pharmaceutical industry.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps. Moreover, the word “substantially” when used with an adjective or adverb is intended to enhance the scope of the particular characteristic, e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

1. A supercritical fluid-facilitated exfoliation method, the method comprising:
loading a layered material powder into a variable-volume reactor, the variable-volume reactor comprising:
an elongated enclosure;
a piston moveably disposed within the elongated enclosure, the piston dividing an interior of the elongated enclosure into a first chamber and a second chamber,
wherein loading the layered material powder into the variable-volume reactor comprises loading the layered material powder into the first chamber;
injecting a pressurized fluid into the first chamber;
increasing the temperature of the first chamber to a predetermined temperature by heating the first chamber;
increasing the pressure of the first chamber up to a pressure higher than the critical pressure of the pressurized fluid by injecting a hydraulic fluid into the second chamber, wherein the piston moves towards the first chamber reducing the volume of the first chamber in response to injecting the hydraulic fluid into the second chamber;
obtaining an intercalated layered material powder by intercalating the pressurized fluid between layers of the layered material powder, wherein intercalating the pressurized fluid between layers of the layered material powder comprises maintaining the temperature and pressure condition within the first chamber for a predetermined amount of time; and
exfoliating the intercalated layered material powder by expanding the pressurized fluid within the first chamber, wherein expanding the pressurized fluid within the first chamber comprises discharging the hydraulic fluid from the second chamber, wherein the piston moves towards the second chamber increasing the volume of the first chamber in response to discharging the hydraulic fluid from the second chamber.

2. The method of claim 1, wherein loading the layered material powder into the variable-volume reactor comprises loading a stacked two-dimensional material powder into the first chamber, the stacked two-dimensional material powder comprising at least one of graphite powder, dichalcogenide powder, silicate clay powder, hexagonal boron nitride powder, tungsten disulfide powder, and molybdenum disulfide powder.

3. The method of claim 1, wherein injecting the pressurized fluid into the first chamber comprises injecting at least one of carbon dioxide, water, ethanol, methanol, propanol, methane, ethane, propane, butane, and ethylene into the first chamber.

4. The method of claim 3, wherein loading the layered material powder into the variable-volume reactor comprises loading a stacked two-dimensional material powder into the first chamber, the stacked two-dimensional material powder comprising at least one of graphite powder, dichalcogenide powder, silicate clay powder, hexagonal boron nitride powder, tungsten disulfide powder, and molybdenum disulfide powder.

5. The method of claim 1, wherein loading the layered material powder into the variable-volume reactor comprises loading graphite powder into the first chamber.

6. The method of claim 5, wherein injecting the pressurized fluid into the first chamber comprises injecting pressurized CO2 into the first chamber.

7. The method of claim 6, wherein increasing the temperature of the first chamber comprises heating the first chamber up to a temperature in a range of 31° C. to 300° C.

8. The method of claim 7, wherein increasing the pressure of the first chamber comprises injecting the hydraulic fluid into the second chamber to increase the pressure within the first chamber up to 400 bar.

9. The method of claim 8, wherein injecting the hydraulic fluid into the second chamber comprises injecting at least one of water, a mixture of water and ethylene glycol, hydraulic oil, and a high temperature oil into the second chamber.

10. The method of claim 1, wherein the elongated enclosure comprises a jacket encompassing an outer surface of the elongated enclosure, wherein increasing the temperature of the first chamber to the predetermined temperature comprises circulating at least one of water, a mixture of water and ethylene glycol, hydraulic oil, and a high temperature oil at the predetermined temperature through the jacket.

11. The method of claim 1, wherein maintaining the temperature and pressure condition within the first chamber comprises maintaining the temperature and pressure condition within the first chamber for a period in a range of 2 minutes to 600 minutes.

12. A method for producing graphene, the method comprising:
loading graphite powder into a variable-volume reactor, the variable-volume reactor comprising:
an elongated enclosure;
a piston moveably disposed within the elongated enclosure, the piston dividing an interior of the elongated enclosure into a first chamber and a second chamber,
wherein loading the graphite powder into the variable-volume reactor comprises loading the graphite powder into the first chamber;
injecting pressurized CO2 into the first chamber;
increasing the temperature of the first chamber to a temperature in a range of 31° C. to 300° C. by heating the first chamber;
increasing the pressure of the first chamber up to a pressure higher than the critical pressure of pressurized CO2 by injecting at least one of water, a mixture of water and ethylene glycol, hydraulic oil, and a high temperature oil into the second chamber, wherein the piston moves towards the first chamber reducing the volume of the first chamber in response to injecting water into the second chamber;
maintaining the temperature and pressure condition within the first chamber for a predetermined amount of time in a range of 2 minutes to 600 minutes; and
expanding the pressurized CO2 within the first chamber by discharging the at least one of water, a mixture of water and ethylene glycol, hydraulic oil, and a high temperature oil from the second chamber, wherein the piston moves towards the second chamber increasing the volume of the first chamber in response to discharging the at least one of water, a mixture of water and ethylene glycol, hydraulic oil, and a high temperature oil from the second chamber.

13. A system for producing exfoliated layered materials, the system comprising:
an elongated enclosure;
a piston moveably disposed within the elongated enclosure, the piston configured to divide an inner volume of the elongated enclosure into a first chamber and a second chamber;
a powder inlet port connected in powder communication with the first chamber, the powder inlet port configured to allow for introducing a powder into the first chamber;
a fluid injection port connected in fluid communication with the first chamber, the fluid injection port configured to allow the injection of a fluid into the first chamber;
a hydraulic mechanism connected in fluid communication with the second chamber, the hydraulic mechanism configured to urge the piston to move along a longitudinal axis of the elongated enclosure, the hydraulic mechanism comprising:
a hydraulic fluid reservoir containing a hydraulic fluid; and
a hydraulic pump connected between the hydraulic fluid reservoir and the second chamber, the hydraulic pump configured to pump the hydraulic fluid into and out of the second chamber, wherein the piston moves towards the first chamber responsive to the hydraulic fluid being pumped into the second chamber, and wherein the piston moves towards the second chamber responsive to hydraulic fluid being pumped out of the second chamber; and
a temperature control mechanism coupled to the elongated enclosure, the temperature control mechanism configured to control the temperature of the first chamber.

14. The system of claim 13, further comprising a powder discharge port connected to the first chamber, the powder discharge port configured to allow the discharge of the powder out of the first chamber.

15. The system of claim 14, wherein the temperature control mechanism comprises a jacket encompassing an outer surface of the elongated enclosure and a circulation system connected in fluid communication with the jacket, the circulation system configured to control the temperature of the first chamber by circulating at least one of water, a mixture of water and ethylene glycol, hydraulic oil, and high temperature oil within the jacket.

16. The system of claim 15, wherein the fluid comprises at least one of CO2, CH4, N2, H2, water, ethanol, methanol, propanol, ethane, propane, butane, and ethylene.

17. The system of claim 16, wherein the powder comprises a stacked two-dimensional material.

18. The system of claim 17, wherein the stacked two-dimensional material powder comprises at least one of graphite powder, dichalcogenide powder, silicate clay powder, hexagonal boron nitride powder, tungsten disulfide powder, and molybdenum disulfide powder.

19. A system for producing graphene, the system comprising:
an elongated enclosure;
a piston moveably disposed within the elongated enclosure, the piston configured to divide an inner volume of the elongated enclosure into a first chamber and a second chamber;
a powder inlet port connected in powder communication with the first chamber, the powder inlet configured to allow for introducing graphite into the first chamber;
a gas injection port connected in fluid communication with the first chamber, the gas injection port configured to allow the injection of CO2 into the first chamber;
a hydraulic mechanism connected in fluid communication with the second chamber, the hydraulic mechanism configured to urge the piston to move along a longitudinal axis of the elongated enclosure, the hydraulic mechanism comprising:
a water reservoir;
a pump connected between the water reservoir and the second chamber, the pump configured to pump water into and out of the second chamber, wherein the piston moves towards the first chamber responsive to water being pumped into the second chamber, and wherein the piston moves towards the second chamber responsive to water being pumped out of the second chamber;
a temperature control mechanism coupled to the elongated enclosure, the temperature control mechanism configured to control the temperature of the first chamber; and
a powder discharge port connected to the first chamber, the powder discharge port configured to allow the discharge of the powder out of the first chamber.

20. The system according to claim 19, wherein the temperature control mechanism is configured to control the temperature of the first chamber at a temperature in a range of 31° C. to 95° C., and wherein the hydraulic mechanism is configured to increase the pressure within the first chamber up to a pressure in a range of 73 bar to 400 bar by injecting water from the water reservoir into the second chamber.
